(19) United States
(12) Patent Application Publication
(10) Pub. No.: US 2009/0302031 A1
(43) Pub. Date: Dec. 10, 2009

(54) Microwave Heater

(75) Inventor: Marcel Mallah, Peine (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FRICKE UND MALLAH MICROWAVE TECHNOLOGY GMBH, Peine (DE)

(21) Appl. No.: 12/478,264

(22) Filed: Jun. 4, 2009

Related U.S. Application Data
(63) Continuation of application No. PCT/EP2007/010530, filed on Dec. 5, 2007.

(30) Foreign Application Priority Data
Dec. 6, 2006 (DE) 10 2006 057 780.9
Jun. 19, 2007 (DE) 10 2006 028 595.9

(51) Int. Cl. H05B 6/68; H05B 6/64

(52) U.S. Cl. 219/681; 219/761; 219/698; 219/702

(57) ABSTRACT

The invention relates to a microwave heater comprising a plurality of microwave generators each emitting microwaves at a frequency in a range of frequencies ranging from 300 MHz to 5.8 GHz which couple into objects to be heated. At least one of the microwave generators emits the microwaves at a first frequency of an upper part of the range of frequencies, the microwaves of the first frequency displaying a first of depth of penetration into the objects to be heated; and at least one other of the microwave generators emits the microwaves at a second frequency of a lower part of the range of frequencies, the microwaves of the second frequency displaying a second depth of penetration into the objects to be heated, the first penetration depth being substantially smaller than the second penetration depth.

### CROSS REFERENCE TO RELATED APPLICATIONS

This application is a continuation of International Patent Application PCT/EP2007/010530 entitled “Microwave Heater”, filed on Dec. 05, 2007, and claiming priorities to German Patent Applications No. DE 10 2006 028 595.9 entitled “Mikrowellenheizungseinrichtung,” filed Jun. 19, 2007, now abandoned, and DE 10 2006 057 780.9 also entitled “Mikrowellenheizungseinrichtung,” filed Dec. 06, 2006, also now abandoned.

### FIELD OF THE INVENTION

The invention generally relates to a microwave heater. More particularly, the invention relates to a microwave heater for heating and, thus, drying ceramic materials and articles molded of ceramics. Even more particular, the invention relates to a microwave heater comprising several microwave generators for emitting microwaves at a frequency in a range of 300 MHz to 5.8 GHz and coupling said microwaves into objects to be heated and dried.

### BACKGROUND OF THE INVENTION

Due to the increasing performance of microwave technology and due to the progresses in automated control of irradiating ceramic materials with microwaves within industrial drying devices, this technology is usable for an increasing range of applications. Thus, the central aspect of the present invention is an industrial microwave heater for treating various materials, particularly for drying ceramic materials and mineral isolation materials. The special physical properties of microwaves, specifically the ability to permeate the surface of an irradiated object containing water or another solvent displaying a dipole moment and the ability to couple into the volume of the irradiated object to generate heat therein, make it preferable to use microwaves for quickly heating solid bodies containing water or other solvents displaying a dipole moment in industrial drying processes.

With common drying devices using conventional heat generation methods, the introduction of energy to the core of an object to be dried generally takes a lot of time, as the gradient of temperature only slowly propagates from the surface layer into the interior of the product to be dried. In contrast, microwaves have a high penetration depth even with thermally isolating products like ceramic materials and also heat the irradiated volume more uniform by directly coupling to the volume to be heated.

The danger of overheating the outer surfaces of the object to be dried does not exist with microwaves to the same extent as with conventional drying methods in which the heat transfer is concentrated to the surface of the objects to be dried.

Thus, microwave driers are in principle well suited for all drying tasks with regard to materials and molded articles containing water or other solvents displaying a dipole moment, i.e. a high dielectric constant.

For these advantages, microwave drying is used in the manufacture of soot or diesel particulate filters (RPF) which are also called micro particle filters and which are needed in high numbers. These large-scale ceramic articles having a microcomb structure and preferably a cylindric geometry are needed by the automobile industry in very high numbers. They mostly consist of silicon carbide (SiC) or mixed ceramics having a high content of silicon carbide. For drying such ceramic articles, drying furnaces of various construction and with different heating systems (gas or electric heating) are used. Microwave furnaces are becoming more and more important due to the advantages indicated above.

Besides microwave chamber furnaces, which are used for special applications to heat objects to be dried in batches, continuous drying facilities are often used for heat-treating ceramic materials. The drying methods applied to different tasks are realized by the arrangement, control, and parameterization of the various components of the drying facilities. In tunnel furnaces, the objects to be dried are generally conveyed through the heating zones by a conveyor belt, and the drying time may be adjusted by the conveyor speed. Microwave generators, being arranged in the heating zones preferably above and below the conveyor belt, irradiate microwaves onto the objects to be dried by means of antennas of the microwave generators directed into the drying zones. The objects to be dried, such as bodies of micro particle filters, are to be heated up as uniformly as possible over their entire volume over their drying path through the tunnel furnance.

Further, such microwave dryers are often equipped with additional hot air injection systems and corresponding exhaust equipment for supporting the drying processes and for removing the exhalation produced.

As a further supplemental device, moistening systems available in various constructions may be installed to provide a controlled vapor atmosphere within the drying zones. Active moistening avoids an over-drying of the surface, which may easily lead to surface tension and to the formation of cracks in sensitive ceramic surfaces.

Special tunnel furnaces, which are called hybrid drying facilities, may also comprise further heating elements or heat sources, which are operated electrically or by burning gas, in addition to the microwave generators.

However, the drying processes applied in known industrial microwave drying facilities have substantial drawbacks with regard to the homogeneity of the distribution of the electromagnetic field and the heating power density in the volume of the objects to be dried. This has particular negative effects with regard to the large-scale ceramic molded articles, and, particularly considering particulate filters, results in the reduction of quality. For example, this reduction in quality can include a reduction of the filter body lifetime or of the filter efficiency, seriously reducing the usability of the diesel particulate filters. It is therefore necessary to achieve heat transfer that is as uniform as possible by means of the irradiating microwaves into the volume of the objects to be dried, i.e. within the ceramic bodies and at their surfaces. Doing so avoids the cracks, tensions, and deformations often occurring with known microwave drying facilities. It has been tried to achieve this end by means of distributing the microwave field over the entire drying path as uniformly as possible. More specifically, it was intended to enhance the homogeneity and the stability of the microwave field and to achieve a more uniform drying process for all treated ceramic bodies by means of certain measures like the arrangement of additional reflectors and special antenna constructions.

Further, it has been proposed to avoid the aforementioned drying defects by using a plurality of microwave reflectors arranged at predetermined points within the drying chambers or distributed within single drying zones at certain reflection angles. However, only limited improvements in the drying process could be achieved with these known methods despite the considerable technical efforts for homogenizing the field distribution and focusing it on the objects to be dried.

From published German Application DE 10 201 299 A1, a drying device is known in which a ceramic comb bodies made as catalyzer supports for automobile exhaust cleaning systems are heated in a highly humid environment with a humidity content of at least 70% and in which the comb bodies are simultaneously irradiated with microwaves. The high humidity in the furnace reduces the various strong shrinking processes and the formation of cracks and wrinkles. However, the high input of humidity in this known device also results in undesired lengthened drying times and also increases the required heating power for the drying process.

A device disclosed in published German Application DE 10 353 784 A1 attempts to purposefully control the drying process of ceramic molded articles by using sensors to determine the spatial distribution and position of the objects to be dried in a drying chamber. Further, the sensors are used for controlling the microwave output power and/or the irradiation direction of a plurality of microwave generators arranged in the drying chamber. The frequency of the microwave generators used ranges in frequency from 300 MHz to 300 GHz.

This known method requires laborious signal processing plus and an electronic control connected to the surveying sensors. It may also be assumed that operating the surveying sensors and the electronic control of the microwave generators a working an enclosure with a high heat and humidity will result in a high number of failures. Thus, doubts exist that the sensor system (image processing) will properly function over longer periods of time. Further, the high technical requirements of this solution also have to be considered.

All microwave drying equipment used in practice uses microwave generators operating at a frequency of 2.45 GHz, i.e. at the same frequency of common kitchen microwave devices. This ISM-frequency (frequency for industrial, scientific and medical application) is one of the microwave frequencies that are allowed worldwide for heating purposes. A drying process applying only this frequency does not provide satisfying results and is associated with some problems due particularly to the low penetration depth of the microwaves into the ceramic material.

Thus, there still exists a need for a microwave heater which avoids the drawbacks of known drying facilities and which allows for a tension-free and uniform drying, particularly within the volume of large scale ceramic objects. Further, the required drying times in the drying facilities used should be shortened thereby reducing costs.

### SUMMARY OF THE INVENTION

The present invention relates to a microwave heater comprising a plurality of microwave generators each emitting microwaves at a frequency in a range of frequencies ranging from 300 MHz to 5.8 GHz which couple into objects to be heated, wherein at least one of the microwave generators emits the microwaves at a first frequency of an upper part of the range of frequencies, the microwaves of the first frequency displaying a first of depth of penetration into the objects to be heated, and wherein at least one other of the microwave generators emits the microwaves at a second frequency of a lower part of the range of frequencies, the microwaves of the second frequency displaying a second depth of penetration into the objects to be heated, the first penetration depth being substantially smaller than the second penetration depth.

In a more particular aspect, the present invention relates to a microwave furnace for drying ceramic filter bodies for diesel particulate filters, the furnace comprising a plurality of microwave generators each emitting microwaves which couple into the ceramic filter bodies, wherein at least one of the microwave generators emits the microwaves at a first frequency of an upper range of frequencies ranging from 2.45 GHz to 5.8 GHz, the microwaves of the first frequency displaying a first of depth of penetration into the objects to be heated, and wherein at least one other of the microwave generators emits the microwaves at a second frequency of a lower range of frequencies ranging from 900 MHz to 1,000 MHz, the microwaves of the second frequency displaying a second depth of penetration into the objects to be heated, the first penetration depth being substantially smaller than the second penetration depth, and comprising a humidity control for controlling the humidity in the surroundings of the objects to be heated.

According to the invention, a microwave heater is provided which comprises at least two microwave generators irradiating the objects to be heated, which are particularly objects to be dried, with microwaves of a first frequency of an upper frequency band of the internationally allowed microwave frequencies (ISM-frequencies), and—simultaneously or successively—with microwaves of a second frequency of a lower frequency band of the internationally allowed microwave frequencies. Doing this, the microwaves of the upper frequency provides for a smaller penetration depth but a more uniform field distribution of the electromagnetic field of the microwaves, whereas the microwaves of the lower frequency provides for high penetration depth and a better coupling of the microwaves in the deeper layers of the irradiated volume of the objects to be heated.

As described in the prior art section, a drying process only applying a frequency of 2.45 GHz, i.e. at the same frequency of common kitchen microwave devices, does not provide for satisfying results and is associated with some problems which are particularly due to the low penetration depth of the microwaves into the ceramic material. It has been found by the inventor that the penetration depth is an important measure for the place of the heat formation within the volume of the material to be heated. The size and the geometry of the objects to be heated also play a major role with regard to the formation of the inner temperature profile. According to the fact that the distribution of the inner heat generation with regard to the thickness of the material to be heated may be influenced by the microwave frequency, the present invention proposes to irradiate the objects to be heated with at least two different microwave frequencies, preferably of a high frequency of 2.45 GHz or higher and of a low frequency of 1,000 MHz or lower. Detailed investigations of the behavior of the microwave radiation upon coupling in solid bodies have had the result that the penetration depth of the microwave radiation inversely proportionally decreases with increasing frequencies. Thus, the higher the frequency of the microwave radiation used, the lower the penetration depth. In this context it has also been found that the heat generation within the objects to be heated is more strongly concentrated within the surface ranges with higher frequencies of the microwave radiation used, when the dielectric properties of the objects to be heated are kept constant.

The application of these principles in a microwave heater according to the invention allows for more effective drying by means of irradiating ceramic goods to be dried with microwaves of different frequencies adapted to each other and of attuned microwave powers. This use of the new microwave heater avoids the disadvantages of known microwave heaters.

The microwave heater according to the invention is provided with a plurality of microwave generators which are of such a technical construction that they emit microwaves at different frequencies of an upper and a lower frequency range onto the objects to be dried.

To support the drying process, a heating device according to the present invention may be supplemented with further components such as a hot air injection system and an exhaust system for supporting the drying process and for removing of humidity from the heating zone.

On the other hand, one or several additional moisturizing systems within the drying zones of a tunnel furnace or a drying chamber increase the uniformity of the drying process of the work pieces under a controlled damp or vapor atmosphere. Thus, the formation of cracks at and deformations of the surface of the ceramic shaped parts can be minimized and a considerable increase in quality can be achieved.

In an actual construction of a microwave drying furnace, care should be taken for the irradiation of the objects to be dried from all sides, considering the reflections of the microwaves within the furnace chamber. With the arrangement of a plurality of microwaves generators, there often exists a complex microwave field which encloses the objects to be heated but which may be very non-homogenously distributed without further measures. This is due to the nature of the microwave radiation and to the specific shape and design of the furnace chamber which acts as a microwave resonator.

Other features and advantages of the present invention will become apparent to one with skill in the art upon examination of the following drawings and detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 depicts a microwave furnace according to the invention designed as a tunnel drying furnace; and

FIG. 2 depicts a microwave furnace according to the invention designed as a chamber furnace.

### DETAILED DESCRIPTION

As already mentioned, several microwave drying devices of various designs are known from drying ceramic shaped bodies in the prior art. Particularly with objects to be dried of greater dimensions, like with constructional units of sanitary techniques or with particularly important ceramic filter inserts of silicon carbide (SiC) for diesel particulate filters in the automotive industry, microwave generators emitting at a frequency of 2.45 GHz are used. Quality deficiencies including formation of cracks and deformations of the objects to be dried are due to a partial overheating of the surface areas and non-uniform heat gradients and are up to now fought in the manner already described.

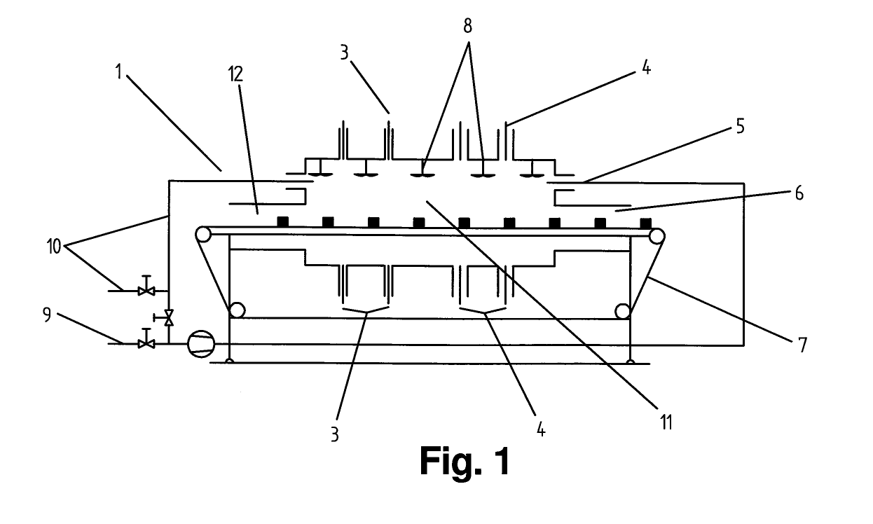

Referring now in greater detail to the drawings, the microwave drying device according to the invention depicted in FIG. 1 does not generally differ from known concepts and is made as a continuously working tunnel drying furnace 1 for ceramic shaped bodies with several microwave generators 3 and 4. Absorber zones 6 and 12 are provided at the entrance and at the exit of the goods to be dried into and out of the tunnel furnace, respectively. These absorber zones 6 and 12 are attuned to the kind and geometry of the objects to be dried. Further, these two absorber zones serve to avoid the exit of microwave radiation into the surroundings of the furnace, particularly out of the furnace entry area 12 and the furnace exit area 6. If large scale products or higher product throughputs have to be dealt with, combined reflection and absorption locks may be used in the entrance and exit areas.

Coupling the high and low frequency microwaves is effected via a plurality of coupling elements 3 and 4 inserted into the ceiling and the bottom area of the drying chamber, which may be designed as slot antennas attuned to the emitting frequency, so that preferably a uniform distribution of the microwaves is assured even with a stepwise irradiation of the microwaves.

To achieve a particularly uniform distribution of the microwave, the arrangement of several field guiding devices 8 in the ceiling area of the drying chamber 11 is advantageous.

As depicted in FIG. 1 the objects to be dried are conveyed through the drying chamber 11 of the furnace via a continuously driven conveyor belt 7. At the same time, defined amounts of fresh air 9 are continuously injected into the drying chamber depending on the present drying task to remove the humidity from the drying process. The same amounts of air are sucked off at an exit 10.

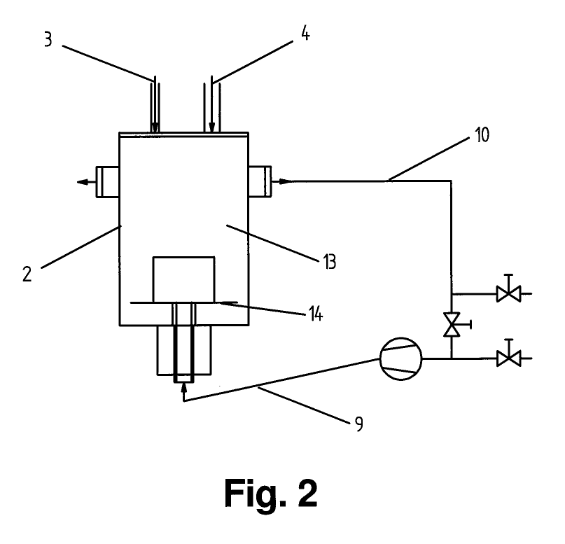

FIG. 2 depicts a further embodiment of the invention as a chamber furnace 2. Here, the objects to be dried are placed on a rotating plate 14 arranged within a drying chamber 13 and rotated in a manner similar to that of a common kitchen microwave furnace during the drying process. The coupling of the microwaves of different frequencies according to the present invention is affected via the coupling elements 3 and 4. The chamber furnace 2 also needs continuous ventilation via an air intake 9 and an air exhaust 10 for removing humidity.

The objects to be dried of large size may be ceramic shaped bodies intended for use as filter inserts for micro particulate filters. The comb shaped cell structure of these ceramic shaped bodies is very sensitive to higher differences in temperature and humidity during drying, resulting in material stress, cracks, and breakage, thereby endangering the usability. The microwave generators 3 for generating microwaves of a higher frequency and the microwave generators 4 for generating microwaves of a lower frequency are arranged above and below the conveyor belt within the single drying zones.

The high frequency wave generators 3 operate at a frequency of 2.45 GHz. In this frequency range, the microwaves couple in areas of the objects to be heated which are close to the object's surface which results in an increased heat formation in these areas.

If, for example, the microwave frequency is increased by means of a suitable dielectric from 2.45 GHz to 5.8 GHz, not only the penetration depth of the radiation is decreased but also the heating power density directly below the surface of the objects to be dried is increased.

Vice versa it has to be stated that particularly microwaves of the frequency range of 900 to 1000 MHz have a much higher penetration depth into the ceramic material to be dried. Thus, the input of heat in the inner volume of the objects to be dried is increased, resulting in a significant increase of the speed of the drying process.

However, microwave fields of his lower allowable frequency range often display increased non-homogeneities in the field distribution so that the arrangement of suitable reflectors in the drying chambers may be advantageous in certain cases.

In the present case, the lower frequency microwave generators 4 operate at a frequency of 915 MHz and are mainly installed in the back part of the tunnel furnace.

In the combined use of the two different frequencies of 2.45 GHz and 915 MHz according to the invention, different penetration depths of the coupled-in microwaves in the ceramic shaped bodies to be dried are used. The heating power density realized both in the areas close to the surface and in the volume of the ceramic comb filter provides for a much more uniform temperature gradient and thus for a continuously quick and stress free drying process.

Besides the microwave frequency—and thus the penetration depth—used, which has been analyzed as an important measure for the geometric distribution of the heat generation within the volume of the material to be tried, the size and geometry of the objects to be dried also plays a considerable role in formation of the inner temperature profile.

According to the invention the microwave energy can thus be used for various material geometries and for various drying processes by means of selecting particular frequencies within the ranges indicated.

In connection with further technological measures like a variable pressure level of the atmosphere present in the drying zones, even difficult drying tasks can be solved at low stress and relatively low temperatures.

As special microwave fields with very high energy densities may be formed by means of the microwave drying technology according to the present invention, the construction of space-saving compact drying devices is possible.

With the new multi-frequency method, all layers of a product, even the deeper areas, are directly and instantaneously subjected to an adequate level of microwave energy. This has a particular advantage with ceramic products to be dried. That is, the products are kept, both chemically and physically, homogenous, and thus their geometric structure is also conserved.

The microwave drying device according to the present invention allows for a drying treatment particularly of large scale ceramic shape bodies which achieves a much higher throughput of products while at the same time producing stress and crack free products as compared to known devices.

All deformations at the surface and other irregularities and quality defects of the ceramic drying objects are avoided by means of the microwave multi-frequency treatment during the drying process according to the invention, resulting in considerable cost savings.

The microwave heating device according to the invention is also suited for heating materials other than ceramics and for uses other than drying, including: heating of preforms in the manufacture of constructional parts of fiber composite or wood particle materials and heat-induced curing or cross linking of various substances.

Many variations and modifications may be made to the preferred embodiments of the invention without departing substantially from the spirit and principles of the invention. All such modifications and variations are intended to be included herein within the scope of the present invention, as defined by the following claims.

1. A microwave heater comprising a plurality of microwave generators each emitting microwaves at a frequency in a range of frequencies ranging from 300 MHz to 5.8 GHz which couple into objects to be heated, wherein at least one of the microwave generators emits the microwaves at a first frequency of an upper part of the range of frequencies, the microwaves of the first frequency displaying a first of depth of penetration into the objects to be heated, and wherein at least one other of the microwave generators emits the microwaves at a second frequency of a lower part of the range of frequencies, the microwaves of the second frequency displaying a second depth of penetration into the objects to be heated, the first penetration depth being substantially smaller than the second penetration depth.

2. The microwave heater of claim 1, wherein the upper part of the range of frequencies is above 1 GHz, and wherein the lower part of the range of frequencies ranges from 1 GHz downwards.

3. The microwave heater according to claim 1, wherein the upper part of the range of frequencies ranges from about 2.45 GHz to 5.8 GHz, whereas the lower part of the range of frequencies ranges from 900 MHz to 1,000 MHz.

4. The microwave heater according to claim 1, wherein the microwave heater is a microwave tunnel furnace having at least one heating module.

5. The microwave heater according to claim 1, wherein the microwave heater is a microwave chamber furnace.

6. The microwave heater according to claim 1, wherein the microwave heater is a microwave hybrid furnace comprising at least one supplementary heating device.

7. The microwave heater according to claim 6, wherein the at least one supplementary heating device is a hot air injection system.

8. The microwave heater according to claim 6, wherein the at least one supplementary heating device is a gas heating.

9. The microwave heater according to claim 6, wherein the at least one supplementary heating device is an electric heating.

10. The microwave heater according to claim 1, further comprising a humidity control for controlling the humidity in the surroundings of the objects to be heated.

11. The microwave heater according to claim 1, further comprising a control activating the at least one of the microwave generators emitting at the first frequency and the at least one other of the microwave generators emitting at the second microwave frequency independently of each other.

12. A microwave furnace for drying ceramic filter bodies for diesel particulate filters, the furnace comprising a plurality of microwave generators each emitting microwaves which couple into the ceramic filter bodies, wherein at least one of the microwave generators emits the microwaves at a first frequency of an upper range of frequencies ranging from 2.45 GHz to 5.8 GHz, the microwaves of the first frequency displaying a first of depth of penetration into the objects to be heated, and wherein at least one other of the microwave generators emits the microwaves at a second frequency of a lower range of frequencies ranging from 900 MHz to 1,000 MHz, the microwaves of the second frequency displaying a second depth of penetration into the objects to be heated, the first penetration depth being substantially smaller than the second penetration depth, and comprising a humidity control for controlling the humidity in the surroundings of the objects to be heated.
